(19) United States
(12) Patent Application Publication
(10) Pub. No.: US 2025/0218045 A1
(43) Pub. Date: Jul. 3, 2025

(54) OUTLIER DETECTION IN VISUAL DATA DATASETS

(71) Applicant: Samasource Impact Sourcing, Inc., San Francisco, CA (US)

(72) Inventors: Jerome PASQUERO, Montreal (CA); Justin Chi Hou SZETO, Montreal (CA); Frédéric Elie RATLE, Montréal (CA); Eric ZIMMERMANN, Montreal (CA)

(73) Assignee: Samasource Impact Sourcing, Inc., San Francisco, CA (US)

(21) Appl. No.: 18/991,218

(22) Filed: Dec. 20, 2024

Related U.S. Application Data
(60) Provisional application No. 63/615,119, filed on Dec. 27, 2023.

(51) Int. Cl. G06T 7/00; G06T 5/92

(52) U.S. Cl. CPC G06T 7/97; G06T 5/92; G06T 2207/20081

(57) ABSTRACT

Systems and methods for determining outlier elements in datasets. An assessment dataset is received, and characteristics of its various elements are measured or determined. A baseline dataset is used to determine a predetermined threshold based on the measured or determined characteristics of the baseline dataset's elements. Elements from the assessment dataset whose characteristics fail to meet or exceed the predetermined threshold are marked as outliers and are routed to alternative or different processing. Such alternative or different processing is different from processing for non-outlier elements. The various elements may be pre-processed to adjust one or more characteristics of the elements prior to measuring or determining the characteristics that determine whether an element is an outlier or not.

### CROSS-REFERENCE TO RELATED APPLICATION

This application claims priority from U.S. Provisional Patent Application No. 63/615,119, entitled “OUTLIER DETECTION IN VISUAL DATA DATASETS” filed on Dec. 27, 2023, which is hereby incorporated by reference as if set forth in full in this application for all purposes.

### TECHNICAL FIELD

The present invention relates to image and video processing. More specifically, the present invention relates to systems and methods for assessing point clouds, videos, and images in a dataset to determine outliers relative to the dataset or to other datasets.

### BACKGROUND

The increase in interest in and implementation of artificial intelligence has led to an increased demand for services catering to that field. There has been a related increase in demand for not just trained machine learning models but also in training data that can be used to train such models.

Sadly, when it comes to image recognition models, training datasets that are properly annotated are needed and such datasets can be scarce. The scarcity results from the almost ironic nature of such annotated datasets—annotated datasets are needed to train machine learning models but such datasets need to be annotated by humans.

Unfortunately, when a new unannotated dataset is received, this is generally sent to an annotator who may or may not be specifically trained for the type of annotation that the dataset may require. Furthermore, it is not uncommon for new datasets to have elements that negatively affect an annotator's efficiency. As an example, in a 100-image dataset, there might be 5-10 images that are incorrectly or insufficiently processed, that are unsuitable for annotation, or that require additional scrutiny from annotator(s). Absent clear instructions as to what to do with such images, the annotator will need to segregate these images and either process these differently or seek further instructions.

Similarly, some annotators are experienced in dealing with specific types of annotations or specific types of images. As an example, a dataset may have 150 images of which 30 are nighttime images. An annotator who is experienced in daylight images may have difficulty processing these nighttime images or may take a long time in processing the images. A more efficient approach would be to segregate the nighttime images and to have them processed/annotated by an annotator who is well-versed in nighttime images.

In another scenario, a dataset with mostly one type of images may have other types of images that may present difficulties to an annotator. Similar to the example above, instead of having one annotator be slowed down by the different types of images in the dataset, segregating the different images and having another annotator deal with the different images is a more efficient approach.

There is therefore a need for systems and methods that can determine, from a dataset, which elements are outliers and which can segregate/mark these outliers for different processing. Preferably, such outliers can be determined relative to the other elements in the same dataset or relative to one or more other datasets.

### SUMMARY

The present invention provides systems and methods for determining outlier elements in datasets. An assessment dataset is received, and characteristics of its various elements are measured or determined. A baseline dataset is used to determine a predetermined threshold based on the measured or determined characteristics of the baseline dataset's elements. Elements from the assessment dataset whose characteristics fail to meet or exceed the predetermined threshold are marked as outliers and are routed to alternative or different processing. Such alternative or different processing is different from processing for non-outlier elements. The various elements may be pre-processed to adjust one or more characteristics of the elements prior to measuring or determining the characteristics that determine whether an element is an outlier or not.

In a first aspect, the present invention provides a method for assessing a first dataset relative to at least one second dataset, the method comprising:
a) receiving a first dataset for assessment, said first dataset having multiple elements;
b) determining at least one metric for at least one of said multiple elements of said first dataset;
c) comparing metrics determined in step b) with metrics for elements of at least one second dataset;
d) determining which elements of said first dataset conform to at least one predetermined condition, said at least one predetermined condition being based on results of step c);
e) autonomously executing at least one predetermined action for said elements of said first dataset that conform to said at least one predetermined condition;
wherein said first dataset and said at least one second dataset comprise visual data;
wherein said first dataset comprises visual data for annotation to result in annotated data, said annotated data being for use in machine learning applications.

In a second aspect, the present invention provides a method for assessing an assessment dataset relative to at least one baseline dataset, the method comprising:
a) receiving said assessment dataset for assessment, said first dataset having multiple elements;
b) receiving at least one baseline dataset;
c) determining at least one metric for at least one of said multiple elements of said assessment dataset;
d) determining said at least one metric for elements of said at least one baseline dataset;
e) comparing metrics obtained in step c) with metrics for elements of said at least one baseline dataset obtained in step d);
e) determining which elements of said assessment dataset conform to at least one predetermined condition, said at least one predetermined condition being based on results of step e);
f) autonomously executing at least one predetermined action for said elements of said first dataset that conform to said at least one predetermined condition;
wherein said assessment dataset and said at least one baseline dataset comprise visual data;
wherein said assessment dataset comprises visual data for annotation to result in annotated data, said annotated data being for use in machine learning applications.

In a third aspect, the present invention provides a method for assessing a dataset, the method comprising:
a) receiving said dataset, said dataset having multiple elements;
b) determining at least one metric for at least one of said multiple elements of said dataset;
c) determining at least one predetermined limit for said at least one metric;
d) determining which elements of said dataset conform to at least one predetermined condition, said at least one predetermined condition being based said at least one predetermined limit;
e) autonomously executing at least one predetermined action for said elements of said dataset that conform to said at least one predetermined condition;
wherein said dataset comprises visual data for annotation to result in annotated data, said annotated data being for use in machine learning applications.

### BRIEF DESCRIPTION OF THE DRAWINGS

The embodiments of the present invention will now be described by reference to the following figures, in which identical reference numerals in different figures indicate identical elements and in which:

FIG. 1 is a block diagram of a system for implementing a method according to one aspect of the present invention;

FIG. 2 is a block diagram of submodules used in one or more modules used in the system illustrated in FIG. 1; and

FIG. 3 is a flowchart detailing the steps in a method according to one aspect of the present invention.

### DETAILED DESCRIPTION

In one aspect, the present invention relates to systems and methods for assessing a dataset relative to either itself or relative to other datasets. This assessment is to be performed with a view to identifying outliers and segregating such outliers for specific processing. Similarly, the assessment may be performed with a view towards identifying the non-outliers and marking such non-outliers for more conventional processing.

The dataset that is to be assessed is the assessment dataset while the dataset(s) to be used as the baseline are the baseline dataset(s).

The assessment is executed by measuring one or more metrics for each of the elements in the various datasets. The measurements for each element are then stored. Based on the measurements for the baseline datasets, a determination is made as to what measurements constitute a threshold or baseline. Based on this determined baseline, determined after a review of all the measurements for the various baseline datasets, the measurements for the assessment datasets are assessed. Elements of the assessment dataset whose measurements are not “acceptable” based on the threshold are marked as outliers and may be segregated for different processing. Of course, what is acceptable in terms of measurements depends on the circumstances such as the characteristic being measured. As an example, if an image's black levels are being measured, given a dataset of mostly nighttime images, then images with high black levels are considered acceptable while images with low black levels (meaning bright images) are outliers. Similarly, if an image's black level is being measured and a baseline dataset has mostly daytime images, then images with a high black level (meaning dark images) are considered outliers.

It should be clear that what is considered acceptable or not acceptable in terms of a measurement may be predetermined or may be set by a user. As an example, if a dataset is being assessed relative to itself in terms of black levels, a threshold may be set at 80%, meaning that a black level measurement that accounts for 80% or more of the images as being acceptable may be set. Thus, if 80% or more of the images in the dataset have a black level of at least x units, then an image that has less than x units would be considered unacceptable and, as such, that image would be considered an outlier and would be marked for segregation for different processing. Similarly, if another image has a black level that is greater than x units, then that image would be processed in a manner similar to the majority of the images in the dataset.

For datasets to be assessed relative to another dataset, the assessment dataset would have one or more specific characteristics of its elements measured. The baseline dataset would also have the same or similar specific characteristics measured as well. Then, one or more baseline thresholds based on the measurements for the elements in the baseline dataset would be determined. The baseline thresholds determined would then be used to assess the elements in the assessment dataset to determine which of its elements are outliers and which elements will be processed normally. As an example, if the desired threshold for non-outliers is 95%, then a threshold for the measured characteristic is determined such that 95% of the elements in the baseline dataset will conform to be at or above the threshold (the threshold being a minimum level of acceptance), assuming that values above the threshold are acceptable. Similarly, if the threshold is such that it is a maximum acceptable value, then the threshold is set such that 95% of the elements in the baseline dataset will have a measurement that is at or below the set threshold.

It should be clear that the threshold is only determined once the characteristics of the elements of the baseline dataset (whether the baseline dataset is the same as the assessment dataset or is another different dataset) have been measured. Once these measurements have been conducted, the acceptable threshold is set, based on whether the threshold measurement is a floor (i.e. a minimum) or a ceiling (i.e. a maximum) for a predetermined percentage of acceptability. That is, if the predetermined percentage of acceptable elements is set to 90%, then, based on the measurements of the baseline dataset, the threshold value for the measured characteristic is set such that 90% of the elements in the baseline dataset conform to or exceed the threshold.

In terms of processing, non-outlier elements are processed in a normal manner. Outlier elements or elements marked as outliers because their measured characteristic does not meet or exceed the set threshold are measured in a different manner. In one implementation, non-outlier elements such as images set for annotation are assigned to annotators in a regular manner. Outlier elements, however, are assigned to annotators who may have more training or more experience in a particular type of image annotation or who may have more experience annotating the outlier type of images. As an example, if non-outlier images are daytime images and outlier images are dark, potentially nighttime images, then the outlier images in the dataset are set to be assigned to annotators with more experience in annotating nighttime or darker images.

Similarly, non-outlier elements may be processed in a manner similar to how the baseline dataset was processed. As the non-outlier elements are similar (at least in terms of the measured characteristics) to the baseline dataset, then these non-outlier elements can be processed similarly. For the outlier elements, these can be processed in some other manner as outlined above.

It should be noted that, prior to measuring the characteristics of the elements in a dataset, these elements may undergo one or more pre-processing steps. These pre-processing steps may enhance the elements such that the characteristics to be measured are easier to measure or such that the pre-processing produces the characteristics to be measured. As an example, a pre-processing step that adjusts the histogram of an image can increase or decrease the pixel intensities in an image. Thus, if histogram equalization is applied to an image, this increases the contrast in an image and increases/adjusts the black levels, thereby increasing/decreasing an image's black levels. Such a pre-processing step would make light images lighter and dark images darker and would clearly increase/decrease an image's black levels. Thus, if the characteristic to be measured is an image's black levels, this pre-processing step can easily place an image to be an outlier or a non-outlier. Alternatively, the pre-processing step may apply a function to an image that calculates one or more metrics relative to the image and these one or more metrics are the characteristics that determine if the image is an outlier or not.

It should also be noted that, while the above notes the measuring of a characteristic to determine if an image is an outlier, multiple characteristics may be measured for the same ends. As an example, an image's levels of contrast and its balance of colors may be measured. The image may be determined to be an outlier if either one of these two characteristics is outside of acceptable levels. Similarly, the image may be considered an outlier only if both characteristics are outside of acceptable levels. Thus, for implementations that measure multiple characteristics, a determination of whether the image is an outlier or not may be based on any one of these measured multiple characteristics, any subset of these measured multiple characteristics, or all of these measured multiple characteristics. As an example, if 3 characteristics are measured (e.g. black levels, contrast levels, and color balance), then the image may be an outlier if any one of these characteristics is outside acceptable levels. Alternatively, the image may be an outlier if any two of these three characteristics are outside of acceptable levels or, as a final alternative, a status of outlier is only applied to the image if all three of its measured characteristics are outside acceptable levels. And, in other configurations, any subset of the three being outside of acceptable levels may be enough to render the image as an outlier. For such a configuration, a single one of these measured characteristics, regardless of the values of the other two characteristics, would be sufficient to have the image marked as an outlier.

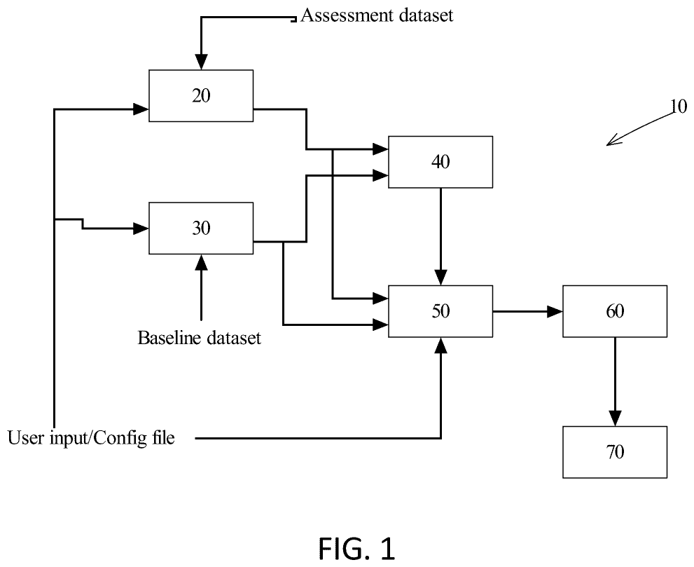

In terms of implementation, the system implementing the various aspects of the present invention may be broken down into a number of specific hardware/software modules as illustrated in FIG. 1. As can be seen, the system 10 includes an assessment dataset module 20, a baseline dataset module 30, a database module 40, a comparison module 50, an output module 60, and a routing module 70.

In operation, the assessment dataset module 20 receives an assessment dataset and applies whatever functions or pre-processing is necessary based on user input. The assessment dataset module 20 also measures one or more characteristics from the pre-processed data based on user input. The resulting data from the pre-processing and measurements can then be stored in a database using the database module 40. The baseline dataset module 30 receives a baseline dataset and, much like the assessment dataset module 20, applies whatever functions or pre-processing is necessary based on user input. The baseline dataset module 30 also performs the measurements for the relevant characteristics based on user input. The data from the pre-processing and from the measurements can also be stored in the database using the database module 40.

Once the relevant data from the baseline dataset and the assessment dataset have been stored in the database, the measured characteristics can be compared using the comparison module 50. The result of the comparison from the comparison module 50 is sent to the output module 60. This result may include marking specific elements of the assessment dataset as outlier elements. It should be clear that the predetermined conditions that determine if an element is an outlier or a non-outlier are applied using the comparison module based either on user inputs or based on predetermined settings.

After relevant elements of the assessment dataset have been marked as outliers (or as non-outliers as the case may be), the various elements are routed to their suitable processing queues by way of the routing module 70. As should be clear, the baseline dataset is not processed but only serves as a comparison baseline. The assessment dataset, on the other hand, will have its elements routed to either regular processing (i.e. for non-outlier elements) or to non-ordinary or to alternative processing for outlier elements. The routing of these outlier elements is determined by the routing module.

It should also be clear that, once the measured characteristics of a baseline dataset have been stored in the database, these can be retrieved and used by the comparison module. As such, it may not be necessary that a baseline dataset be sent to the baseline dataset module prior to determining which elements of an assessment dataset are outliers. A user would simply need to send the assessment dataset to the assessment dataset module to have its characteristics measured (along with an identification of those characteristics and the level of acceptable measurements of those characteristics) and to identify which baseline dataset to use for a comparison. Assuming that the selected baseline dataset's measured characteristics are available from the database, the system retrieves those measured characteristics and sends those with the user entered comparison parameters (if necessary) and the measured characteristics from the assessment dataset to the comparison module. The comparison module can then perform the comparison between the measured characteristics of the assessment dataset and the retrieved measured characteristics of the baseline dataset based on the comparison parameters. The relevant elements of the assessment dataset are then marked as outliers or as non-outliers as necessary.

It should be clear that the comparison parameters may be set by the user or may be set from predetermined settings. Thus, as an example, a user may determine that elements of assessment dataset A with measured characteristics that are within the measured characteristics of 80% of the baseline dataset B are non-outliers. However, measured characteristics for elements of assessments dataset A that are within the measured characteristics of 90% of the baseline dataset C (different from baseline dataset B) are non-outliers. Of course, a comparison may be made between a specific assessment dataset and a specific baseline dataset for different characteristics. Which characteristics are to be compared by the comparison module, along with values/percentages that are relevant, are determined based on the comparison parameters noted above. Thus, a comparison between two specific datasets may need different percentages and values based on which characteristics are to be compared.

Based on the above, it should be clear that if a user wishes to determine outliers for an assessment dataset based on that same dataset, that assessment dataset may be sent to both the assessment dataset module as well as the baseline dataset module. By doing so, a single dataset can be an assessment dataset while simultaneously operating as a baseline dataset. As an example, outlier elements may be elements whose measured characteristics are outside of 75% of the measured characteristics of elements from the same dataset. For this example, the same dataset is sent as both assessment dataset and baseline dataset and the threshold is set to 75%. Elements of the assessment dataset that are outside of 75% of the measured characteristics for the same dataset are thus marked as being outliers.

For clarity, any pre-processing, adjustments, or functions applied to a dataset, whether an assessment dataset or a baseline dataset, are not applied permanently to images or elements in those datasets. The pre-processing is applied to a copy of a dataset and measurements are conducted. The amended/pre-processed elements are then discarded while the values for the measured characteristics are stored. An unamended/unprocessed version of the original dataset is preserved, and this unprocessed version of the original dataset is what is sent to annotators for processing. As should be clear, specific elements may be marked as outlier or non-outlier but the images that make up that element are untouched prior to being sent to an annotator. The values for the measured characteristics are saved and/or compared as necessary but the pre-processed images/elements are, in one implementation, not saved.

In terms of implementation and characteristics or comparison parameters that may be used, these characteristics or comparison parameters may be characteristics derived from the datasets or they may be calculated in pre-processing steps. Accordingly, such characteristics or comparison parameters may include:
contrast;
clarity;
color levels;
black level;
white level;
image quality;
color balance;
brightness;
signal-to-noise ratio;
resolution; and
number of points in a point cloud.

Note that other parameters or characteristics or data points associated with the datasets may be used to determine if a dataset is an outlier or not. Such may include metadata included or associated with one or more datasets and may be data that is derived from such metadata. Such data and metadata may even be generated by a pre-processing of the dataset or elements of a dataset. As an example, a dataset may be pre-processed by an image descriptor model that outputs a textual description of the contents of the dataset or of the contents of an element of the dataset. These generated descriptors (such as a description of the scene in an image) can then be associated with the relevant image/dataset and can be the basis for determining if the image or dataset or element of a dataset is an outlier or not. Such data (whether pre-existing and associated with the dataset or auto generated during pre-processing of the dataset) may include:
details regarding a place of image/dataset capture;
details regarding a time of image/dataset capture;
details regarding content of image/dataset;
details regarding said image/dataset, with the details being autonomously generated;
text associated with at least one dataset (e.g. metadata associated with a dataset or text that forms part of the content of one or more images/visual data);
data resulting from a detection or classification of content in a dataset (e.g., indoors vs. outdoors, a highway, a landscape, a closeup vs. a panoramic view, the weather conditions in a dataset); and
image embeddings.

For greater clarity, further information and clarification on model and image embeddings may be found at: https://developers.google.com/machine-learning/crash-course/embeddings/video-lecture, the contents of which are hereby incorporated in their entirety by reference.

Other metrics that may be used to determine whether one or more datasets and their elements are outliers or not include:
data that results from a preprocessing of at least one dataset;
data that results from an implementation of a machine learning algorithm on at least one dataset;
distribution of classes that are present in one or more datasets;
distribution of object sizes that are present within one or more datasets.

For greater clarity and information regarding the distributions that are present in one or more datasets, this distribution can be determined in a pre-processing step for the dataset. As an example, the raw dataset can be passed through a pre-processing step that automatically generates details regarding an approximate distribution of objects of interest in the image. The resulting distribution data can be associated with the dataset and this distribution can be used as the basis for determining whether the dataset is an outlier or not.

It should also be clear that, while this document discusses the idea of determining whether a dataset or an element in that dataset is an outlier based on one or more measured/determined criterion, sections or portions of that dataset may also be assessed to determine if such are outliers or not. As an example, instead of assessing if a single element in a dataset is an outlier, multiple elements or whole sequences of elements in the dataset can be assessed according to a selected set of criteria as to whether these are outliers or not.

Regarding the set of criteria to be used to determine if one or more datasets or one or more elements of datasets are outliers, this set of criteria can be a set of criteria with a single element (e.g. brightness of an image) or it can be a set of criteria with multiple elements (e.g. contrast of an image, number of pixels in the image, image depth of the image, text associated with the image, and content of the image). As an example, if a baseline dataset consists of bright, sunlit daytime images of a beach taken at high tide in Huntington Beach in California (with the location and time of the capture of the images being denoted in metadata) and an assessment dataset is that of bright, sunlit daytime images of a boardwalk taken at noon in Redondo Beach in California (again, with the location and time of capture of the images being denoted in metadata), then the assessment dataset can be considered as an outlier based on the location and time of capture of the images in the metadata. Depending on the configuration, the system may be given a set of criteria that the baseline dataset conforms to and any deviation from that set of criteria by the assessment dataset (or its elements) may result in either the assessment dataset (as a whole) or selected elements of the assessment dataset being determined as outliers. Alternatively, the system may be configured so that all of the criteria may need to be deviated from by a dataset or element before that dataset or element is considered to be an outlier. Of course, the system may be implemented as one that is between the two extreme cases detailed above such that a deviation of a given subset of the criteria would need to occur before a dataset or element is considered to be an outlier.

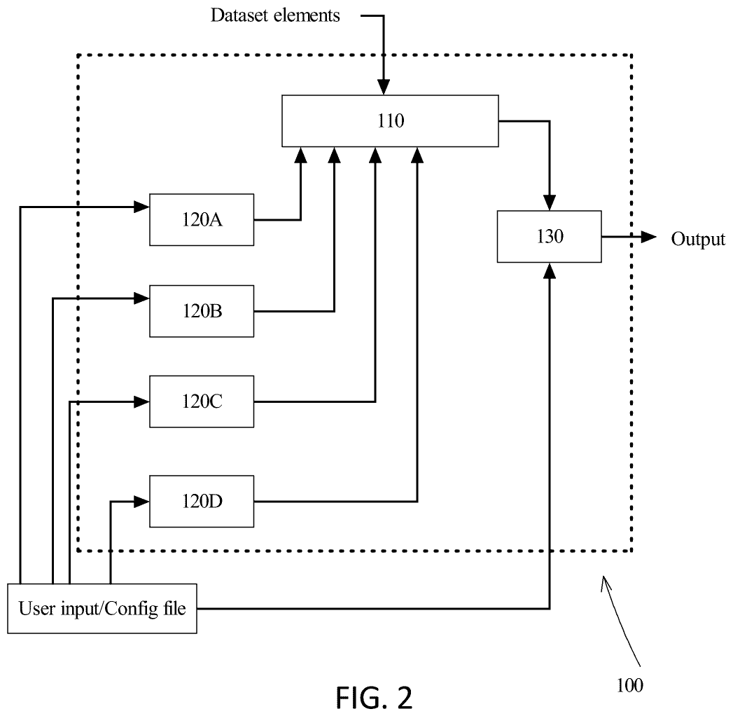

For both the assessment dataset module and the baseline dataset module, the functions are the same—receive datasets, apply pre-processing (if applicable) to the elements of the datasets, and measure one or more characteristics of the resulting elements. Accordingly, the internal components of the assessment dataset module and of the baseline dataset module should be similar. Referring to FIG. 2, a block diagram illustrating the internal components of these modules is illustrated.

From FIG. 2, it can be seen that the dataset module 100 includes an input submodule 110, multiple pre-processing submodules 120A, 120B, 120C, 120D, and a measuring submodule 130. In operation, the input submodule 110 receives an element from a dataset. Each of the pre-processing submodules receives control input that activates or deactivates each submodule and, if an activation signal is received, also received are (where necessary) pre-processing parameters that control the pre-processing applied by a specific pre-processing submodule to the element received by the input submodule. As an example, if a pre-processing submodule is for increasing/accentuating a contrast of an image, the activation signal for that submodule is received along with a parameter that indicates by how much an image's contrast is to be increased (or decreased). Since every pre-processing submodule has a different function and since each pre-processing submodule can be independently activated/deactivated, then multiple pre-processing functions can be applied to a single element (e.g. multiple images adjust functions can be applied to a single image). Accordingly, for one image, the contrast can be increased, the histogram can be adjusted, color balance can be adjusted, sharpening of contours can be applied, and specific pixel values for the image can be scaled/multiplied/reduced as desired. Of course, each one of these functions can be applied by a separate pre-processing submodule and each of these separate pre-processing submodules would receive independent control parameters that would control the extent to which the function would apply to the image.

Once the image has been pre-processed, the pre-processed image with one or more functions applied would be sent to the measuring submodule 130. This measuring submodule 130 also receives control parameters and would measure specific characteristics of the image. Of course, which characteristics are to be measured are controlled by the received control parameters. The values for the measured characteristics, as well as an identification of the element/image that was pre-processed and whose characteristics were measured, are the outputs of the measuring submodule. These outputs are produced by the dataset module for each of the dataset elements and, as explained above, can be stored in the database. As should be clear, the pre-processed image is not saved in the database. And, as explained above, the dataset module may be the assessment dataset module or the baseline dataset module as the processing by both these modules is similar.

For clarity, the parameters supplied to the dataset module and which control which pre-processing submodules are to be active and the parameters for the functions/adjustments applied by the submodules can be user supplied. Alternatively, these activation control signals and the parameters for the functions to be applied may be stored in a configuration file such that a user can select which configuration file to apply to specific datasets. Each configuration file would activate a specific set of pre-processing functions, provide specific parameters for these functions as they are applied to elements in a dataset, and would cause the measurement of specific characteristics for the elements. A configuration file may also be configured such that the measured characteristics for specific baseline datasets are to be used as the baseline data. Thus, a user can, instead of having to select specific pre-processing functions, simply select a preconfigured configuration file that would apply specific pre-processing functions with pre-configured parameters for each of these functions to the various elements of an assessment dataset and the preconfigured configuration file would cause the measurement (and storage) of specific characteristics of the pre-processed elements of the assessment dataset.

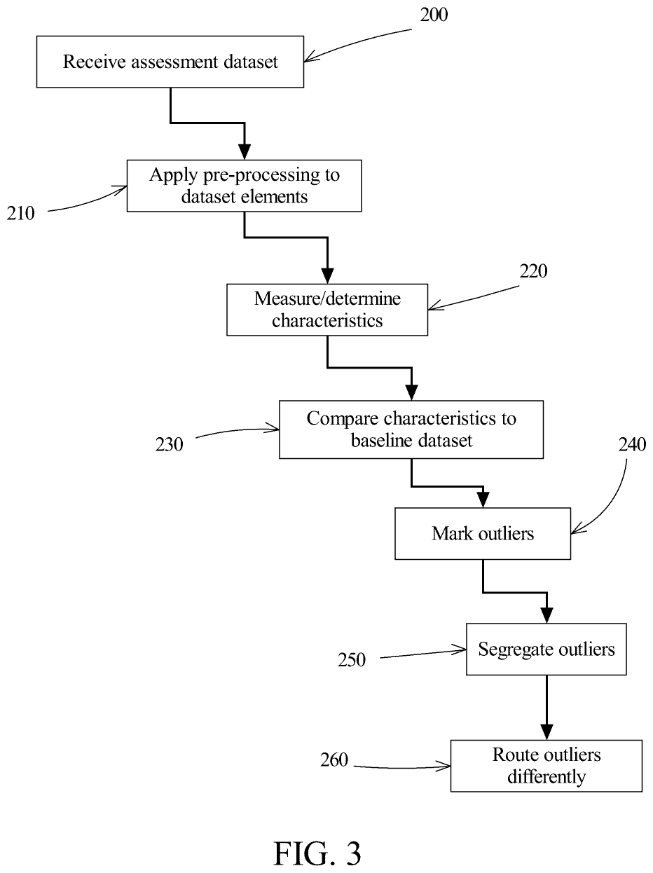

In another aspect, FIG. 3 illustrates a flowchart detailing the steps in a method according to a further aspect of the present invention. In this method, an assessment dataset, having multiple elements, is processed to determine outliers relative to the elements in a baseline dataset. The process begins at step 200, that of receiving the assessment dataset. Pre-processing is then applied to the elements of the assessment dataset (step 210) and characteristics of the elements are then measured or determined (step 220). The measured or determined characteristics are then compared relative to the measured or determined characteristics of elements in a baseline dataset (step 230). Elements of the assessment dataset that do not meet or exceed a threshold based on the measured characteristics of elements in the baseline dataset are marked as outliers (step 240). These outlier elements in the assessment dataset are then segregated for different processing from other elements in the assessment dataset (step 250).

It should, of course, be clear that the measured or determined characteristics of the baseline dataset are obtained by pre-processing the elements in the baseline dataset and then measuring or determining those characteristics prior to storing the values for the measured characteristics. Similarly, it should be clear that the baseline dataset may be the assessment dataset. If such is the case, the measurement or determination of the characteristics for the assessment dataset and for the baseline dataset may occur simultaneously.

It should further be clear that the elements in the assessment dataset and in the baseline, dataset may be visual data such as images or video. The dataset elements may include point clouds, video, images, depth maps, radar data, 3D mesh data, or 3D voxel data. It should also be further clear that these dataset elements may be for annotation and that, after annotation, the annotated dataset elements are for use in machine learning applications. The baseline dataset may be unannotated elements but may also be annotated elements.

It should be clear that the systems and methods of the present invention may be implemented as a preconfigured autonomous system that assesses incoming assessment datasets based on one or more baseline datasets and based on a predetermined set of criteria for comparison. Similarly, the systems and methods of the present invention may be implemented as a user configurable system where the user selects the assessment datasets, the baseline datasets, and the criteria to be used for comparing the various datasets to determine which are outliers and which are not. Or, as a variant, the various systems and methods may be implemented as a semi-user configurable system where a predetermined set of criteria is used for comparison while a user selects the baseline datasets and the assessment datasets. As another variant, the system may be user configurable such that a user selects the set of criteria to be used in comparing one or more predetermined baseline datasets with one or more incoming assessment datasets.

It should be clear that the various aspects of the present invention may be implemented as software modules in an overall software system. As such, the present invention may thus take the form of computer executable instructions that, when executed, implements various software modules with predefined functions.

Additionally, it should be clear that, unless otherwise specified, any references herein to ‘image’ or to ‘images’ refer to a digital image or to digital images, comprising pixels or picture cells. Likewise, any references to an ‘audio file’ or to ‘audio files’ refer to digital audio files, unless otherwise specified. ‘Video’, ‘video files’, ‘data objects’, ‘data files’ and all other such terms should be taken to mean digital files and/or data objects, unless otherwise specified.

The embodiments of the invention may be executed by a computer processor or similar device programmed in the manner of method steps or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g., “C” or “Go”) or an object-oriented language (e.g., “C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A method for assessing a first dataset relative to at least one second dataset, the method comprising:
a) receiving a first dataset for assessment, said first dataset having multiple elements;
b) determining at least one metric for at least one of said multiple elements of said first dataset;
c) comparing metrics determined in step b) with metrics for elements of at least one second dataset;
d) determining which elements of said first dataset conform to at least one predetermined condition, said at least one predetermined condition being based on results of step c);
e) autonomously executing at least one predetermined action for said elements of said first dataset that conform to said at least one predetermined condition;
wherein said first dataset and said at least one second dataset comprise visual data;
wherein said first dataset comprises visual data for annotation to result in annotated data, said annotated data being for use in machine learning applications.

2. The method according to claim 1, wherein said at least one second dataset comprises visual data that has been annotated.

3. The method according to claim 1, wherein said at least one second dataset comprises visual data that is unannotated.

4. The method according to claim 1, wherein said metric is a measurement of a characteristic of said visual data, said characteristic being at least one of:
contrast;
clarity;
color levels;
black level;
white level;
image quality;
color balance;
brightness;
signal-to-noise ratio;
resolution; and
number of points in a point cloud.

5. The method according to claim 1, wherein said visual data is at least one of: images and video.

6. The method according to claim 1, wherein, prior to step b), said elements of said first dataset are pre-processed.

7. The method according to claim 6, wherein pre-processing of said first dataset adjusts a characteristic of said elements.

8. The method according to claim 1, wherein said predetermined condition is having a metric that is at least equal to or exceeding a predetermined threshold based on metrics for multiple elements for said at least one second dataset.

9. The method according to claim 1, wherein said predetermined condition is having a metric that is at most equal to or below a predetermined threshold based on metrics for multiple elements for said at least one second dataset.

10. The method according to claim 1, wherein said at least one predetermined action comprises routing said elements of said first dataset that conform to said at least one predetermined condition to a specific annotator.

11. The method according to claim 1, wherein said first dataset and said second dataset include at least one of: point clouds, video, images, depth maps, radar data, 3D mesh data, 3D voxel data.

12. The method according to claim 1, wherein said metrics include metadata associated with said datasets.

13. The method according to claim 1, wherein said metrics include data associated with said first or second datasets.

14. The method according to claim 12, wherein said metadata includes at least one of:
details regarding a place of image/dataset capture;
details regarding a time of image/dataset capture;
details regarding content of image/dataset;
details regarding said image/dataset that has been autonomously generated;
text associated with at least one dataset;
image descriptor model generated data relating to content in a dataset;
data resulting from a detection or classification of content in a dataset; and
model embeddings.

15. The method according to claim 13, wherein said metrics include at least one of:
data that results from a preprocessing of at least one dataset;
data that results from an implementation of a machine learning algorithm on at least one dataset;
distribution of classes that are present in one or more datasets; and
distribution of object sizes that are present within one or more datasets.

16. The method according to claim 12, wherein said metadata is automatically generated in a pre-processing step applied to one or more datasets.

17. The method according to claim 15, wherein distribution data relating to one or more datasets is automatically determined in a pre-processing step applied to one or more datasets.

18. A method for assessing an assessment dataset relative to at least one baseline dataset, the method comprising:
a) receiving said assessment dataset for assessment, said first dataset having multiple elements;
b) receiving at least one baseline dataset;
c) determining at least one metric for at least one of said multiple elements of said assessment dataset;
d) determining said at least one metric for elements of said at least one baseline dataset;
e) comparing metrics obtained in step c) with metrics for elements of said at least one baseline dataset obtained in step d);
e) determining which elements of said assessment dataset conform to at least one predetermined condition, said at least one predetermined condition being based on results of step e);
f) autonomously executing at least one predetermined action for said elements of said first dataset that conform to said at least one predetermined condition;
wherein said assessment dataset and said at least one baseline dataset comprise visual data;
wherein said assessment dataset comprises visual data for annotation to result in annotated data, said annotated data being for use in machine learning applications.

19. A method for assessing a dataset, the method comprising:
a) receiving said dataset, said dataset having multiple elements;
b) determining at least one metric for at least one of said multiple elements of said dataset;
c) determining at least one predetermined limit for said at least one metric;
d) determining which elements of said dataset conform to at least one predetermined condition, said at least one predetermined condition being based said at least one predetermined limit;
e) autonomously executing at least one predetermined action for said elements of said dataset that conform to said at least one predetermined condition;
wherein said dataset comprises visual data for annotation to result in annotated data, said annotated data being for use in machine learning applications.

20. The method according to claim 19, further including a step of pre-processing said elements of said dataset prior to step b).

21. The method according to claim 20, wherein said step of pre-processing adjusts at least one characteristic of an element being pre-processed.
